(19) United States
(12) Patent Application Publication
(10) Pub. No.: US 2002/0062376 A1
(43) Pub. Date: May 23, 2002

(54) QoS server and control method for allocating resources

(76) Inventor: Kazuhiko Isoyama, Tokyo (JP)

Correspondence Address: WHITHAM, CURTIS & CHRISTOFFERSON, P.C., Suite 340, 11491 Sunset Hills Road, Reston, VA, 20190, US

(21) Appl. No.: 09/988,653

(22) Filed: Nov. 20, 2001

(30) Foreign Application Priority Data
Nov. 20, 2000 (JP) 353170/2000

(51) Int. Cl. G06F 15/173

(52) U.S. Cl. 709/226; 709/229

(57) ABSTRACT

A QoS server having an affinity to a protocol such as MGCP, capable of cooperating with applications without causing a delay in call setup and performing optimum QoS resource allocation is provided. A QoS server is provided with a network monitoring section for monitoring the network state, a network state database for storing network state information obtained at the network monitoring section, a resource allocation computing section for computing resource allocation for an application based on resource requirements with reference to the network state database, a resource allocation database for storing resource allocation information, and a network setup section for setting up the resource allocation on the network based on the resource allocation information.

### BACKGROUND OF THE INVENTION

The present invention relates to a QoS (Quality of Service) server for communications that maintains the quality of service on a network such as an IP network and a control method for allocating resources, in particular, to a QoS server suitable to have existing communications over the telephone network in a network such as an IP network, and a control method for allocating resources.

### DESCRIPTION OF THE RELATED ART

IP networks have been growing rapidly in recent years and are about to become a global communication infrastructure of commercial value. Accordingly, it is supposed that the IP network will be a service base not only for existing data communications but also for communications on every other network such as the telephone network.

Against this background, IETF (Internet Engineering Task Force) has proposed MGCP (Media Gateway Control Protocol) as RFC (Request for Comments) 2705. MGCP is a protocol to apply the IP network to services provided through conventional telephone lines. FIG. 1 is a block diagram showing the structure of a network system to which MGCP is applied.

As can be seen in FIG. 1, the network system comprises: a network 710 (for example, an IP network), a call agent 721, signaling gateways 722a and 722b for connecting signaling networks of existing telephone networks 724a and 724b (external networks) to the call agent 721, and trunk gateways (main signal gateways) 723a and 723b for connecting main signal trunks of the existing telephone networks 724a and 724b to the network 710. The signaling gateways 722a and 722b execute the conversion between signaling signals (751′, 754′, 755′, 756′, 757′, 759′) to/from the existing telephone networks 724a and 724b and packetized signaling signals (751, 754, 755, 756, 757, 759). The trunk gateways 723a and 723b execute the conversion between audio signals (761′, 762′) to/from the main signal trunks of the existing telephone networks 724a and 724b and packetized audio signals (761, 762).

FIG. 2 is a flow diagram showing the conventional call setup process according to MGCP in the above network system. In FIG. 2, a call is originated on the existing telephone network 724a side.

First, the signaling gateway 722a on the calling side sends IAM (Initial Address Message) 751 to the call agent 721 (Step 851). The call agent 721 exchanges CRCX (Create Connection)/ACK (Acknowledgement) 752 with the trunk gateway 723a (Step 852), and exchanges CRCX/ACK 753 with the trunk gateway 723b on the receiving side (Step 853). After that, the call agent 721 sends IAM 754 to the signaling gateway 722b on the receiving side (Step 854). The signaling gateway 722b sends ACM (Address Complete Message) 755 to the call agent 721 (Step 855). The call agent 721 sends ACM 756 to the signaling gateway 722a (Step 856). Subsequently, the signaling gateway 722b sends ANM (Answer Message) 757 to the call agent 721 (Step 857). The call agent 721 exchanges MDCX (Modify Connection)/ACK (Acknowledgement) 758 with the trunk gateway 723a (Step 858), and then sends ANM 759 to the signaling gateway 722a (Step 859). Thus, call setup is implemented at the trunk gateways 723a and 723b using signaling signals 751 to 759. Finally, traffic 761, which is audio signals (voice packets), is transferred from the trunk gateway 723a to the network 710 (Step 861), and traffic 762 is transferred from the network 710 to the trunk gateway 723b (Step 862).

As is described above, the IP network has come to support various applications such as telephone communications from the existing telephone network. Consequently, it is necessitated that application traffics having different traffic characteristics and service levels, namely, different QoS requirements, are transferred on the IP network. The IP network, however, is originally a best-effort type network, and it needs some kind of mechanism to meet the QoS requirements. In the above-mentioned MGCP, the mechanism to meet the QoS requirements for voice packets is not taken into consideration.

Presently, as techniques for providing such QoS, MPLS (Multi Protocol Label Switching, IETF RFC2702), Diffserv (Differentiated Service, IETF RFC2475) and the like are proposed. The document text of those techniques, “RFC3031”, is available from the Web site of IETF (http://www.ietf.org) as IRTF DRAFT.

In MPLS, a fixed-length label is attached to a packet, and the packet is forwarded along a path based on the value of the label. The path to forward the packet: LSP (Label Switched Path), is explicitly controlled, and thus enabling provision of an optimum path based on QoS requirements of traffic, and traffic engineering to conduct load sharing on paths in a network.

In Diffserv, incoming packets are classified in an edge router at the boundary of the Diffserv domain, and a class identifier DSCP (Diffserv Code Point) is attached to each of the packets. At a core router inside the domain, transfer scheduling is conducted based on the value of the DSCP according to the definition of transfer scheduling given to each class: PHB (Per Hop Behavior). In this manner, QoS control is performed not per traffic flow, but per class that includes aggregate flows, and thus enabling scalable QoS to be offered even in a large-scale network.

These techniques provide user traffics with QoS resources such as paths and transfer scheduling, however, in order to offer optimum QoS resource management with a view to the entire network, it is necessary to have another mechanism that computes and provides optimum QoS resource allocation in light of requirements from applications such as MGCP and network state.

With regard to RSVP (Resource Reservation Protocol, IETF RFC2205), which is a protocol to reserve QoS resources for each application traffic by signaling, there has been proposed a mechanism that controls call admission to control QoS resource management from the network-wide point of view (IETF RFC2753).

FIG. 3 is a block diagram showing the call admission control mechanism according to RFC2753.

As shown in FIG. 3, the network 710 is provided with routers 911a to 911c, each including call admission sections 912a to 912c, respectively. One end of the network 710 is connected to another network or a terminal, which is denoted by reference numeral 924a, and the other end is connected to another network or a terminal, which is denoted by reference numeral 924b. The routers 911a to 911c receive packets 951a to 951c respectively, and after executing packet routing, output them as packets 911b to 911d. Each of the call admission sections 912a to 912c exchanges signaling signals 915a to 915d with call admission sections of adjacent routers or other networks/terminals 924a and 924b. In addition, there is provided a policy server 913 including a policy decision section 917 and a policy DB (database) 918.

When the router (911a, 911b, 911c) in the network 710 receives RSVP signaling (915a, 915b, 915c), the call admission section (912a, 912b, 912c) of the router (911a, 911b, 911c) inquires of the policy server 913 whether or not to receive a call by using a call admission inquiry message (916a, 916b, 916c). Having received the call admission inquiry message (916a, 916b, 916c), the policy server 913 determines at the policy decision section 917 to receive or not to receive the call according to a policy 919 stored in the policy database 918, and send back an answer to the call admission section (912a, 912b, 912c) of the router (911a, 911b, 911c).

This mechanism provides the policy function that determines whether or not to receive a call according to the QoS requirements and resource requirements of application traffics indicated by the RSVP signalings 915a to 915c, and the policy 919 stored in the policy database 918, however, does not have the function of performing optimum resource management. Besides, there is a problem that computing resource allocation on each arrival of a call leads to a delay in call setup.

Goyal et al. have proposed DOSA (Distributed Open Signaling Architecture), (Pawan Goyal, et al., “Integration of Call Signaling and Resource Management for IP Telephony”, IEEE Network, May 1999), in which resource management is offered through explicit coordination with call signaling of VoIP (Voice over IP) in decentralized management environment. However, in this architecture, since VoIP signaling and resource management sequences are integrated into explicit coordination, resource management for each call may cause delayed call setup. Additionally, when the resource management system is down due to a failure etc., VoIP may also cease to function. Furthermore, because resources are managed in decentralized management environment, optimum QoS resource management cannot be performed from the network-wide point of view.

Besides, Aukia et al. have proposed RATES (Routing And Traffic Engineering Server), (Petri Aukia, et al., “RATES: A Server for MPLS Traffic Engineering”, IEEE Network, March 2000). In their architecture, a policy server cooperates with modules such as a network state collecting function and a route computing function. This architecture addresses the shortcomings associated with the decentralized management environment by means of central control. However, in the architecture, coordination with applications such as VoIP and the like is unconsidered.

As is described above, QoS is unconsidered in MGCP alone. Besides, in existing QoS techniques, there are several problems that coordination with applications is not fully achieved, that optimum QoS resource allocation cannot be implemented, or that call setup may be delayed.

### SUMMARY OF THE INVENTION

It is therefore an object of the present invention to provide a QoS server having an affinity to a protocol such as MGCP, capable of cooperating with applications without causing a delay in call setup and performing optimum QoS resource management; and a method of the resource allocation.

In accordance with the first aspect of the present invention, there is provided a QoS server, which is used in a network system comprising: a network, main signal gateways for accommodating outside networks in the network and executing conversion of main signals between the network and the outside networks, a call setup server for setting up a call, and signaling gateways for executing conversion of signaling signals between the call setup server and the outside networks. The QoS server is provided with: a network monitoring section for monitoring the network state, a network state database for storing network state information obtained at the network monitoring section, a resource allocation computing section for computing resource allocation for applications based on resource requirements with reference to the network state information, a resource allocation database for storing resource allocation information, and a network setup section for setting up resource allocation on the network based on the resource allocation information.

In accordance with the second aspect of the present invention, there is provided a QoS server, which is used in a network system comprising: a network being connected to outside networks, and a policy server for deciding a policy for the network to set up resource allocation on the network. The QoS server is provided with: a network monitoring section for monitoring the network state, a network state database for storing network state information obtained at the network monitoring section, and a resource allocation computing section for computing resource allocation for applications based on resource requirements with reference to the network state information and notifying the policy server of the result.

In accordance with the third aspect of the present invention, there is provided a QoS server for setting up resource allocation for a network which is connected to outside networks. The QoS server is provided with: a network monitoring section for monitoring the network state, a network state database for storing network state information obtained at the network monitoring section, a user information database for storing setup information, a resource requiring section for making resource requirements with reference to the network state information in the network state database and the setup information in the user information database, a resource allocation computing section for computing resource allocation for applications based on the resource requirements with reference to the network state information, a resource allocation database for storing resource allocation information, and a network setup section for setting up resource allocation on the network based on the resource allocation information.

In accordance with the fourth aspect of the present invention, there is provided a resource allocation control method in a network system comprising: a network, main signal gateways for accommodating outside networks in the network and executing conversion of main signals between the network and the outside networks, a call setup server for setting up a call, and signaling gateways for executing conversion of signaling signals between the call setup server and the outside networks. The resource allocation control method includes the steps of monitoring the network state, storing network state information in a network state database, computing resource allocation for applications based on resource requirements with reference to the network state information stored in the network state database, storing resource allocation information in a resource allocation database, and setting up resource allocation on the network based on the resource allocation information stored in the resource allocation database.

In accordance with the fifth aspect of the present invention, there is provided a resource allocation control method in a network system comprising: a network being connected to outside networks, and a policy server for deciding a policy for the network to set up resource allocation on the network. The resource allocation control method includes the steps of monitoring the network state, storing network state information in a network state database, computing resource allocation for applications based on resource requirements with reference to the network state information stored in the network state database, and notifying the policy server of the result.

In accordance with the sixth aspect of the present invention, there is provided a resource allocation control method for setting up resource allocation for a network which is connected to outside networks. The resource allocation control method includes the steps of: monitoring the network state, storing network state information in a network state database, making resource requirements with reference to the network state information stored in the network state database and setup information stored in a user information database, computing resource allocation for applications based on the resource requirements with reference to the network state information stored in the network state database, storing resource allocation information in a resource allocation database, and setting up resource allocation on the network based on the resource allocation information stored in the resource allocation database.

In accordance with the present invention, a QoS server has interfaces with applications and thereby obtaining QoS requirements and resource requirements from applications. In addition, the QoS server monitors a network, and feeds back network state and traffic state to computation of resource allocation. Consequently, dynamic traffic engineering can be realized without settings by an operator.

Besides, resource allocation is implemented with respect to an aggregation of calls before calls of applications arrive, and therefore the process of resource allocation does not cause a delay in call setup. Furthermore, call setup signaling and resource allocation signaling are partitioned, and thus applications can continue call setup even when a failure occurs in the QoS server.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the structure of a conventional network system, to which MGCP is applied;

FIG. 2 is a flow diagram showing the procedure of call setup operation in MGCP;

FIG. 3 is a block diagram showing a mechanism for call admission control indicated by RFC2753;

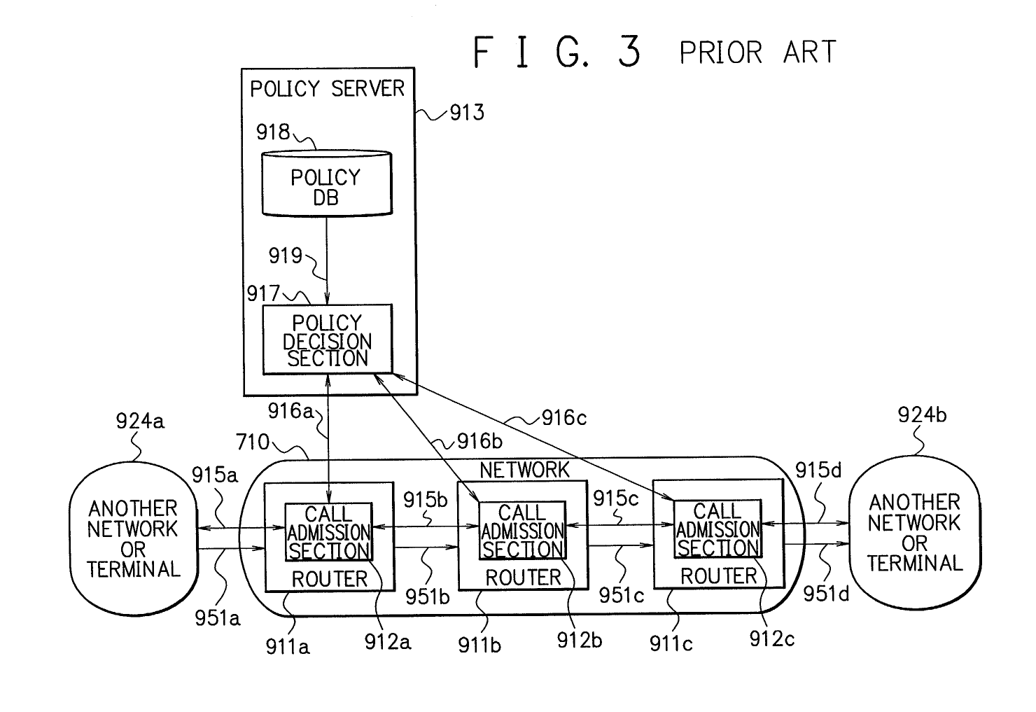

FIG. 4 is a block diagram showing the structure of a network system provided with a QoS server according to the first embodiment of the present invention;

FIG. 5 is a flow diagram illustrating QoS control in the network system shown in FIG. 5;

FIG. 6 is a diagram illustrating the timing for additional resource allocation and resource release;

FIG. 7 is a block diagram showing the structure of a network system provided with a QoS server according to the second embodiment of the present invention;

FIG. 8 is a block diagram showing the structure of a network system provided with a QoS server and a policy server according to the third embodiment of the present invention; and

FIG. 9 is a block diagram showing the structure of a network system provided with a QoS server according to the fourth embodiment of the present invention.

### DESCRIPTION OF THE PREFERRED EMBODIMENT

Referring now to the drawings, a description of preferred embodiments of the present invention will be given in detail.

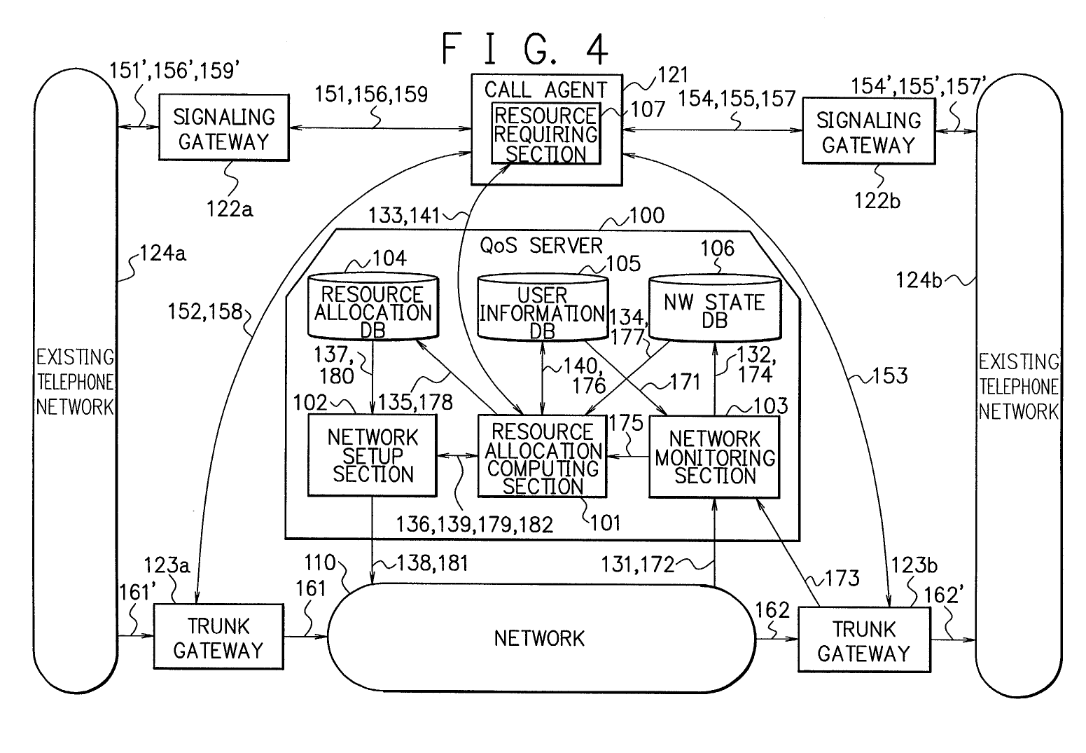

FIG. 4 is a block diagram showing a network system provided with a QoS server according to the first embodiment of the present invention. In the following, an explanation will be given of QoS (Quality of Service) control in the case where an application is VoIP, to which MGCP (IETFRFC2705) is applied.

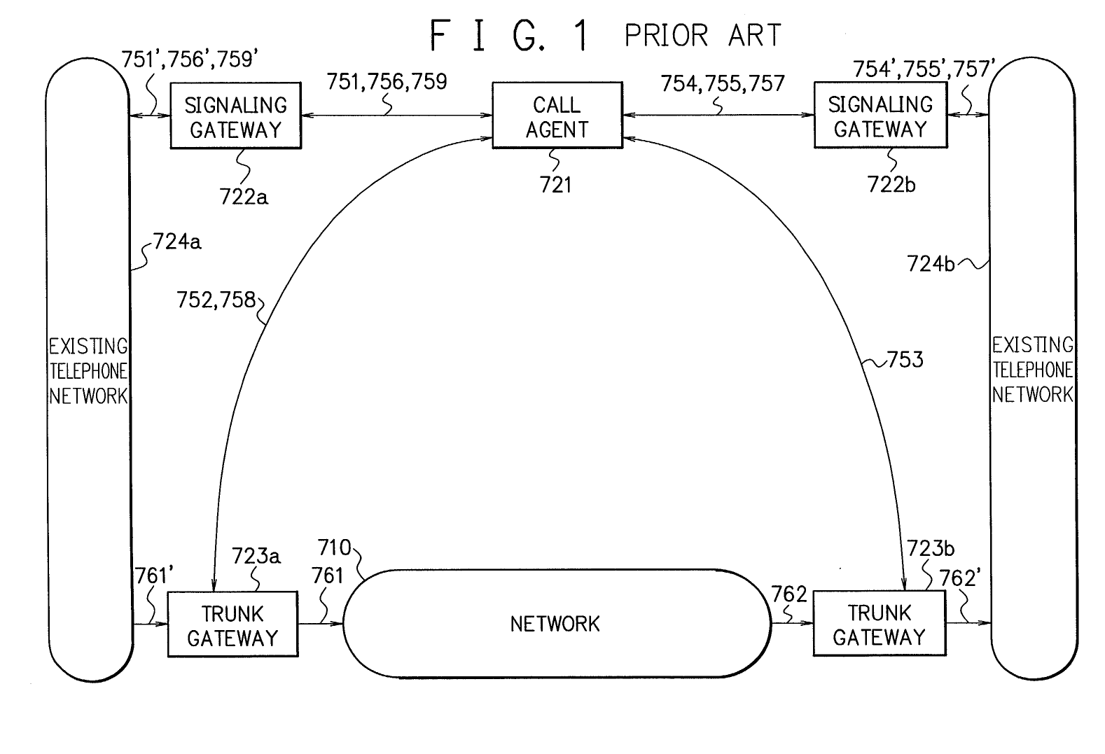

Similarly to the conventional network system shown in FIG. 1, the network system according to the first embodiment comprises: a network 110 (for example, an IP network), a call agent 121, signaling gateways 122a and 122b for relaying signaling signals between an existing telephone network 124a/124b (outside network) and the call agent 121, and trunk gateways 123a and 123b for connecting main signal trunks of the existing telephone networks 124a and 124b to the network 110. In addition, the network system is provided with a QoS server 100 differently from the conventional one. The call agent 121 is a call setup server for setting up a call on the network 110 to exchange conversations between the existing telephone networks 124a and 124b through the network 110. The trunk gateways 123a and 123b are main signal gateways for converting main signals. The QoS server 100 sets and monitors the network 110.

The signaling gateways 122a and 122b execute the conversion between signaling signals (151′, 154′, 155′, 156′, 157′, 159′) to/from the existing telephone networks 124a and 124b and packetized signaling signals (151, 154, 155, 156, 157,159), and thereby connecting signaling networks of the existing telephone networks 124a and 124b to the call agent 121. In the same manner, the trunk gateways 123a and 123b execute the conversion between audio signals (161′, 162′) to/from the main signal trunks of the existing telephone networks 124a and 124b and packetized audio signals (161, 162), and thus connecting the main signal trunks of the existing telephone networks 124a and 124b to the network 110. Namely, in the first embodiment, the application being subject to the QoS control consists of the existing telephone networks 124a and 124b, the call agent 121, the signaling gateways 122a and 122b, and the trunk gateways 123a and 123b.

The call agent 121 is provided with a resource requiring section 107 for sending QoS requirements and resource requirements to the QoS server 100.

The QoS server 100 includes a resource allocation computing section 101 for computing resource allocation for an application based on QoS and resource requirements from the application, a network setup section 102 for setting up the resource allocation on the network 110, a network monitoring section 103 for monitoring the network state, a resource allocation database (DB) 104 for storing resource allocation information, a user information database 105 for storing the QoS and resource requirements from applications, and a network (NW) state database 106 for storing network state information.

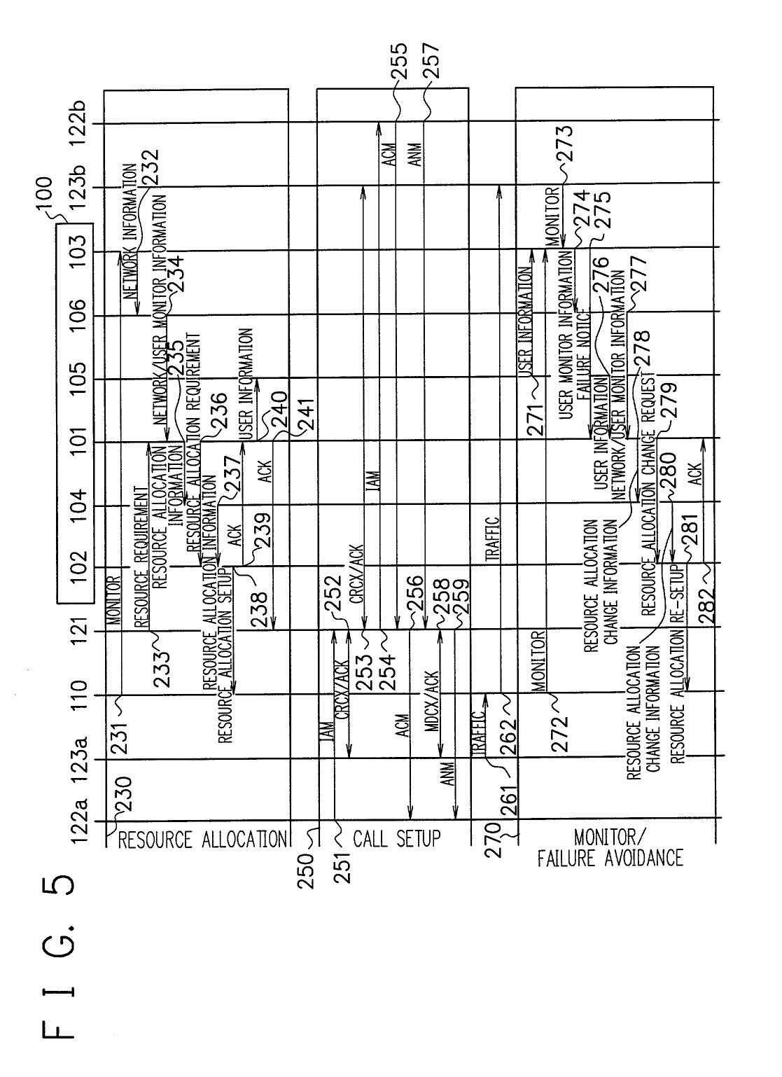

In the following, operations of the QoS control in the network system will be explained referring to FIGS. 4 and 5.

First, preparatory to the arrival of calls, resource allocation is implemented (Step 240). The network monitoring section 103 of the QoS server 100 has been always monitoring the network 110 since the time of initial setting of the network 110 according to an incoming signal 131 from the network 110 (Step 231), and stores information about topology, link metric, and band busy state of the network in the network state database 106 as network information 132 (Step 232).

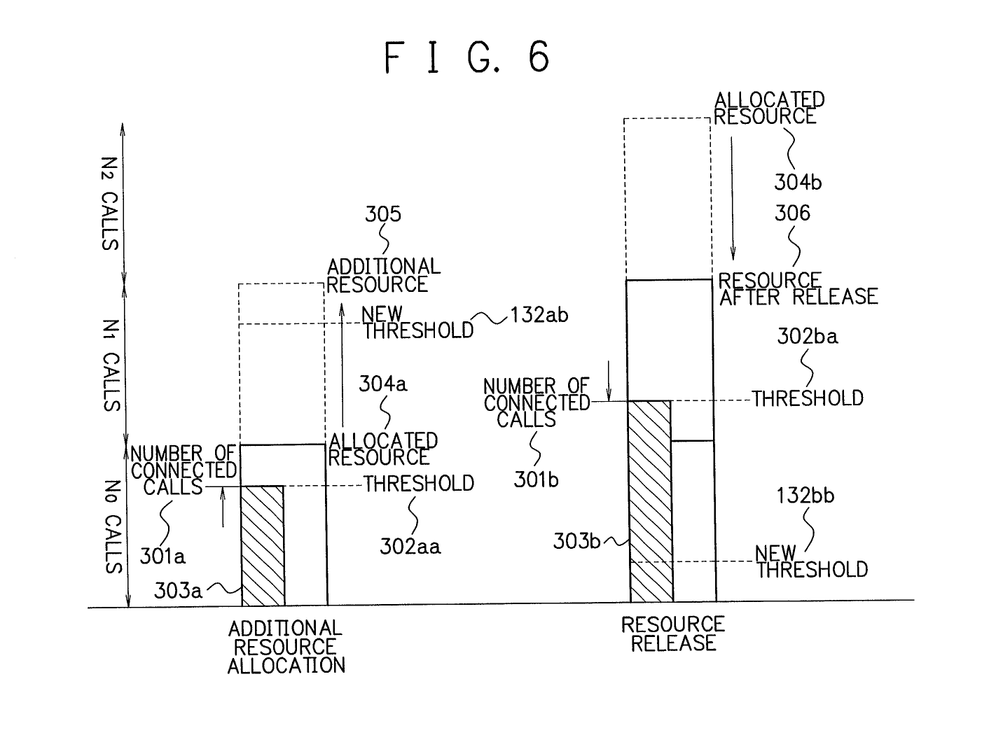

At the time of initial setting of the network 110, the resource requiring section 107 in the call agent 121 requires for resources for traffics of aggregate calls to use, that is, resource requirements for No calls in FIG. 6, in advance of the arrival of calls (Step 233). Resource requirements 133 indicate required delay bound and bandwidth of traffic, packet identification information such as header information, and a source/destination address.

The resource allocation computing section 101 in the QoS server 100 computes resource allocation for resource requirements 133 based on network/user monitor information 134, which is collected by the network monitoring section 103 and stored in the network state database 106 (Step 234). The resource allocation computation includes computations of a path that satisfies the required delay of traffic between a source and a destination address, a link band on the path, and buffer allocation in a network node.

The resource allocation computing section 101 stores the computed resource allocation in the resource allocation database 104 as resource allocation information 135 (Step 235), and requires the network setup section 102 to set up resource allocation by sending resource allocation requirements 136 (Step 236).

The network setup section 102 reads resource allocation information 137 out of the resource allocation database 104 (Step 237), and sets up resource allocation on the network by sending resource allocation setup 138 to the network 110 (Step 238). Thus, setup for the network 110 is completed.

Having completed the setup for the network 110, the network setup section 102 notifies the resource allocation computing section 101 of the completion of setup in the form of an acknowledge signal (ACK) 139 (Step 239).

The resource allocation computing section 101 stores the received resource requirements in the user information database 105 as user information 140 (Step 240), and notifies the call agent 121 of the completion of resource allocation in the form of an ACK (acknowledge signal) 141 (Step 241).

After the completion of resource allocation, call setup signals arrive via the respective signaling gateways 122a and 122b, and thereby call setup is executed (Step 250).

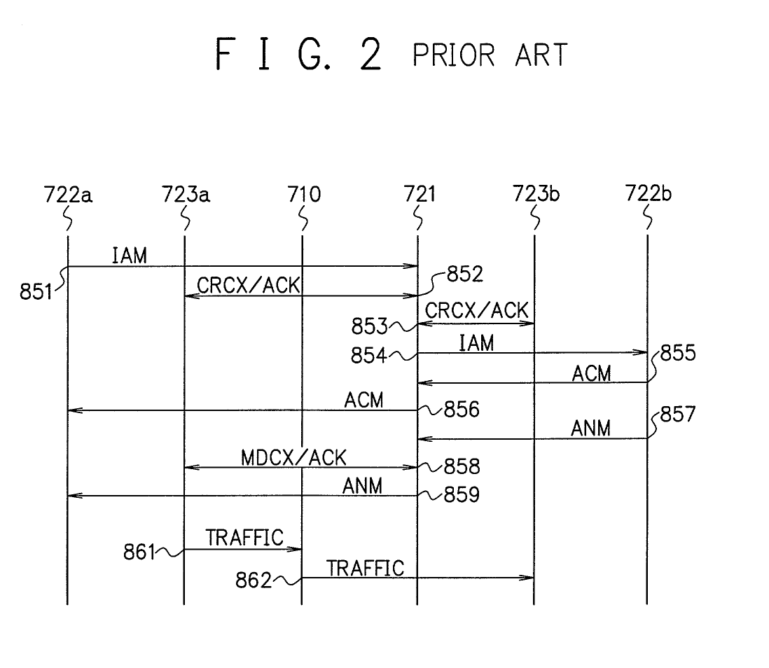

Operations in the call setup process 250 are the same as those in the conventional MGCP shown in FIG. 2. That is, assuming that a call is originated on the existing telephone network 124a side, first, the signaling gateway 122a sends IAM 151 to the call agent 121 (Step 251). The call agent 121 exchanges CRCX/ACK 152 with the trunk gateway 123a (Step 252), and then CRCX/ACK 153 with the trunk gateway 123b (Step 253). After that, the call agent 121 sends IAM 154 to the signaling gateway 122b (Step 254). The signaling gateway 122b sends ACM 155 to the call agent 121 (Step 255). The call agent 121 sends ACM 156 to the signaling gateway 122a (Step 256). Subsequently, the signaling gateway 122b sends ANM 157 to the call agent 121 (Step 257). The call agent 121 exchanges MDCX/ACK 158 with the trunk gateway 123a (Step 258), and then sends ANM 159 to the signaling gateway 122a (Step 259).

After the call setup process 250 is finished, traffic 161 is transferred from the trunk gateway 123a to the network 110 (Step 261). The traffic 161 is then transferred to the trunk gateway 123b as traffic 162 according to the resource allocation set at the network 110, namely, using the path, link band, and buffer obtained by the resource allocation computation (Step 262).

In addition, after the above call setup is finished, the QoS server 100 monitors the network 110 to avoid failures (Step 270).

In this monitoring/failure-avoiding process 270, the network monitoring section 103 in the QoS server 100 learns about the resource requirements that the resource allocation computing section 101 has received by user information 171 stored in the user information database 105 (Step 271). Besides, the network monitoring section 103 monitors the resources allocated to traffics by incoming signals (monitored resource information) 172 from the network 110 (Step 272). The network monitoring section 103 also inquires of the trunk gateway 123b on the receiving side whether the traffic of required quality is being received by application traffic information 173 (Step 273). Subsequently, the network monitoring section 103 stores monitored resource information 172 and application traffic information 173 in the network state database 106 as user monitor information 174 (Step 274). When the network monitoring section 103 detects a failure, or that traffic is not being sent in required quality, it notifies the resource allocation computing section 101 of failure information (failure notice 175) (Step 275).

Having received failure notice 175, the resource allocation computing section 101 retrieves requirements of the application from user information 176 stored in the user information database 105 (Step 276), and re-computes resource allocation so as to avoid a failure based on network state and contents of the failure (network/user monitor information 177) stored in the network state database 106 (Step 277). Then, the resource allocation computing section 101 stores the result in the resource allocation database 104 as resource allocation change information 178 (Step 278), and sends resource allocation change request 179 to the network setup section 102 to request re-setup (Step 279). Incidentally, as re-computation of resource allocation includes a computation of a backup path etc., the backup path may be previously computed on the assumption of a failure at the time of computing resource allocation at Step 134, and stored in the resource allocation database 104.

Next, the network setup section 102 retrieves resource allocation change information 180 stored in the resource allocation database 104 (Step 280), and sends resource allocation re-setup 181 to the network 110 according to resource allocation change request 180 in order to reset the network (Step 281). After the re-setup is completed, the network setup section 102 notifies the resource allocation computing section 101 of the completion by ACK 182 (Step 282).

On the other hand, the resource requesting section 107 in the call agent 121 monitors the number of connected calls, and requests the QoS server 100 for additional resource allocation or resource release according to the number of connected calls. The operations of the additional resource allocation and resource release are the same as the operation at Step 240 (resource allocation process). In the following, the timing of the additional resource allocation and resource release will be explained referring to FIG. 6.

First, an explanation will be given of the additional resource allocation. In FIG. 6, resource 304a for No calls has been previously reserved, and the threshold of additional resource request 302aa has been set within the resource 304a. When the number of connected calls 301a exceeds the additional resource request threshold 302aa, the call agent 121 requests for additional resource 305 for N₁ calls before used resource 303a (shaded area in FIG. 6) exceeds the allocated resources 304a. Thus the call agent 121 sets the new additional resource request threshold 132ab. Naturally, the new threshold 132ab is set within the resources 304a+305 for N₀+N₁ calls.

Next, an explanation will be given of the resource release. Here, resources for N₀+N₁+N₂ calls has been reserved, and the threshold for resource release request 302ba has been already set. When the number of connected calls falls short of the resource release request threshold 302ba, the call agent 121 requests for release of resources for N₂ calls, and sets the new resource release request threshold 132bb for resource after the release 306. In FIG. 6, shaded area indicates used resource 303b.

As is described above, in a network system according to the first embodiment of the present invention, a QoS server is provided with interfaces with applications, and thereby obtaining QoS requirements and resource requirements of applications. Consequently, it is possible to allocate resources that satisfy the requirements of applications. Besides, the network state and traffic state are fed back to resource allocation for applications, and thus enabling resource allocation corresponding to the network state. Additionally, on this occasion, a failure of resources and deterioration in the quality of application traffics, to which resources are allocated, are detected, and thereby resource allocation is modified to avoid a failure.

Consequently, dynamic resource allocation and network design can be realized without settings by an operator.

Furthermore, since resource allocation is executed with respect to an aggregate of calls before calls arrive from applications, the resource allocation process does not cause a delay in call setup. In addition, call setup signaling and resource allocation signaling are isolated from each other, and therefore applications can continue call setup even when failures occur in a QoS server.

Next, the second embodiment of the present invention will be described. Incidentally, in the present invention, the location of the resource requiring section 107 is not limited to inside the call agent (call setup server) 121. The resource requiring section 107 may be set, for example, inside the trunk gateway that actually handles voice packets, or inside the QoS server.

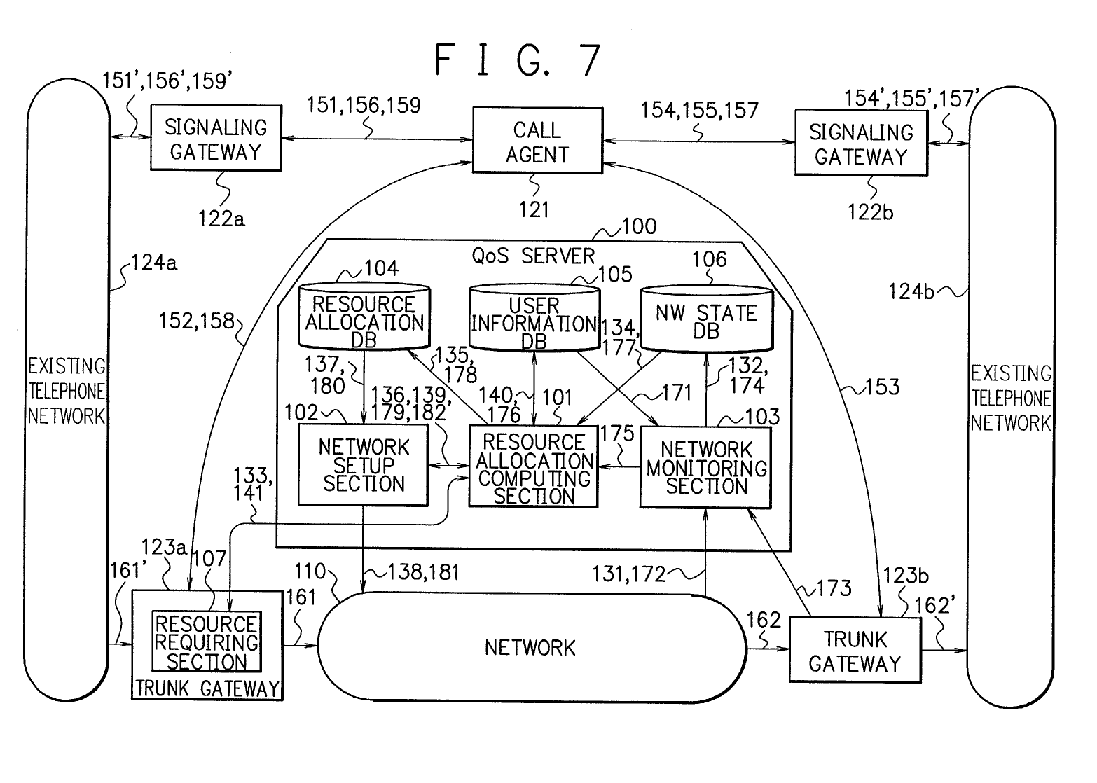

FIG. 7 is a block diagram showing the structure of a network system provided with a QoS server according to the second embodiment of the present invention. In an example of FIG. 7, the resource requiring section 107 is located in the trunk gateway 123a. Here, the resource requiring section 107 monitors the number of set calls according to call setup signaling 158 that the trunk gateway 123a receives from the call agent 121, and produces resource requirements 133 based on the number of calls. Other operations are the same as those in the first embodiment. That is, the second embodiment also includes the steps as follows: (1) traffic requirements and resource requirements are previously obtained to compute path and resource allocation, and the path and resource allocation is conducted before a call arrives; (2) traffic requirements and resource requirements of aggregate calls are obtained to compute path and resource allocation, and the path and resource allocation is conducted; (3) when the number of connected calls exceeds a certain threshold, traffic requirements and resource requirements for additional aggregate calls are obtained to re-compute resource allocation, and the additional resource allocation is conducted; (4) when the number of connected calls underruns a certain threshold, resource release request for aggregate calls are obtained, and the resource release is conducted to reduce reserved resource; and (5) traffic flow on the allocated resources is monitored, and when it is detected that the required quality is not satisfied, path and resource allocation is re-computed and altered.

In the following, the third embodiment of the present invention will be described. In an example of the third embodiment, the present invention is applied to an application that does not have a call agent performing the central control of signaling and a trunk gateway connecting calls, such as RSVP. Here, a policy server for deciding the reception of calls is provided as a substitute for the call agent and the trunk gateway.

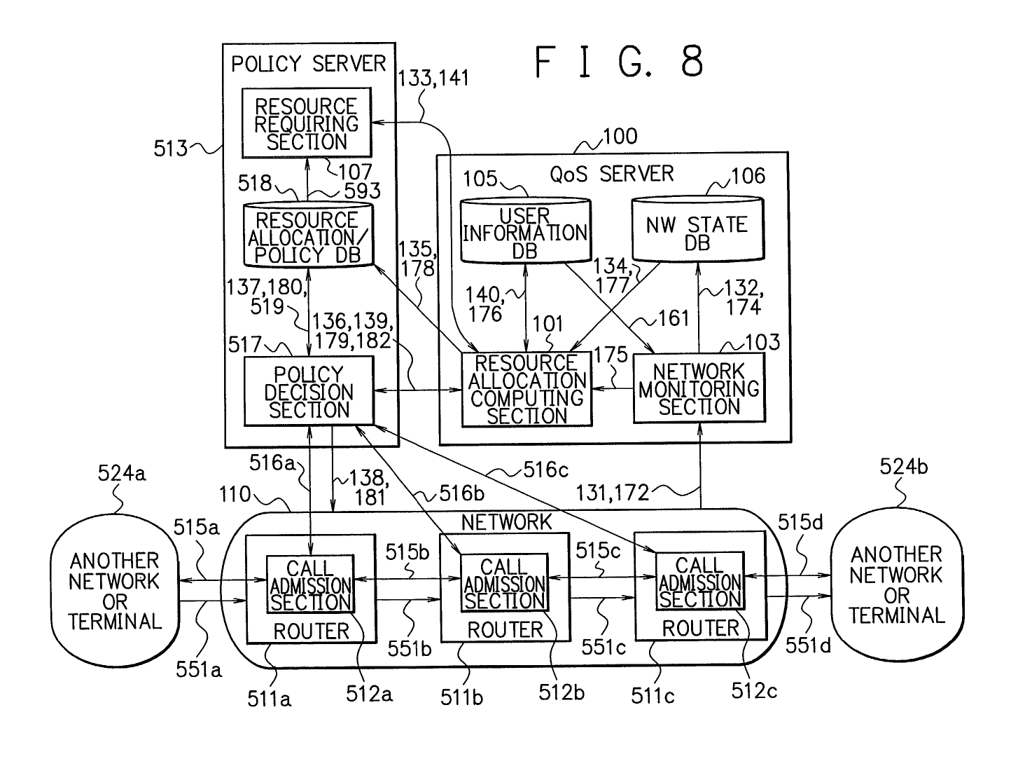

FIG. 8 is a block diagram showing a network system including a QoS server and a policy server according to the third embodiment of the present invention.

In the structure of FIG. 8, the network 110 is provided with routers 511a to 511c, each including call admission sections 512a to 512c, respectively. One end of the network 110 is connected to another network or a terminal, which is denoted by reference numeral 524a, and the other end is connected to another network or a terminal, which is denoted by reference numeral 524b. In FIG. 8, the other networks or terminals 524a and 524b belong to the category of outside networks. The routers 511a to 511c receive packets 551a to 551c, respectively, and after routing the packets, output them as packets 511b to 511d. Each of the call admission sections 512a to 512c exchanges signaling signals 515a to 515d with call admission sections of adjacent routers or other networks/terminals 524a and 524b.

The QoS server 100 includes a resource allocation computing section 101, a network monitoring section 103, a user information database 105, and a network state database 106. As can be seen in FIG. 8, the QoS server 100 is not provided with a network setup section and a resource allocation database differently from the QoS servers shown in FIGS. 4 and 7. In the third embodiment, a policy server 513 carries out their functions.

A resource requiring section 107 is located inside the policy server 513 that makes decision on the reception of calls. Besides, the policy server 513 includes a policy decision section 517 for deciding policies and a resource allocation/policy database 518 for storing resource allocation/policy information 135 and 178. The policy decision section 517 and the resource allocation/policy database 518 also function as a network setup section and a resource allocation database, respectively.

The policy decision section 517 determines to receive or not to receive a call in response to each call admission inquiry message (516a, 516b, 516c) from the call admission section (512a, 512b, 512c) in the router (511a, 511b, 511c), which has received an RSVP signaling signal (515a, 515b, 515c). The resource requiring section 107 monitors information of received calls (policy 519), which is managed by the policy decision section 517 by using information 593 available at the resource allocation/policy database 518, and produces resource requirements 133 based on the number of received calls. Thereby resource setup 138 for new calls is previously executed on the network according to the number of received calls. Thus, when the policy server 513 receives the call admission inquiry message (516a, 516b, 516c) for a new call, it can be decided to receive or not to receive the call by just referring to resource allocation information 137. Consequently, according to the third embodiment of the present invention, the computation of resource allocation does not cause a delay in call setup.

Other operations are the same as those in the first embodiment. That is, the third embodiment also includes the steps as follows: (1) traffic requirements and resource requirements are previously obtained to compute path and resource allocation, and the path and resource allocation is conducted before a call arrives; (2) traffic requirements and resource requirements of aggregate calls are obtained to compute path and resource allocation, and the path and resource allocation is conducted; (3) when the number of connected calls exceeds a certain threshold, traffic requirements and resource requirements for additional aggregate calls are obtained to re-compute resource allocation, and the additional resource allocation is conducted; (4) when the number of connected calls underruns a certain threshold, resource release request for aggregate calls are obtained, and the resource release is conducted to reduce reserved resource; and (5) traffic flow on the allocated resources is monitored, and when it is detected that the required quality is not satisfied, path and resource allocation is re-computed and altered.

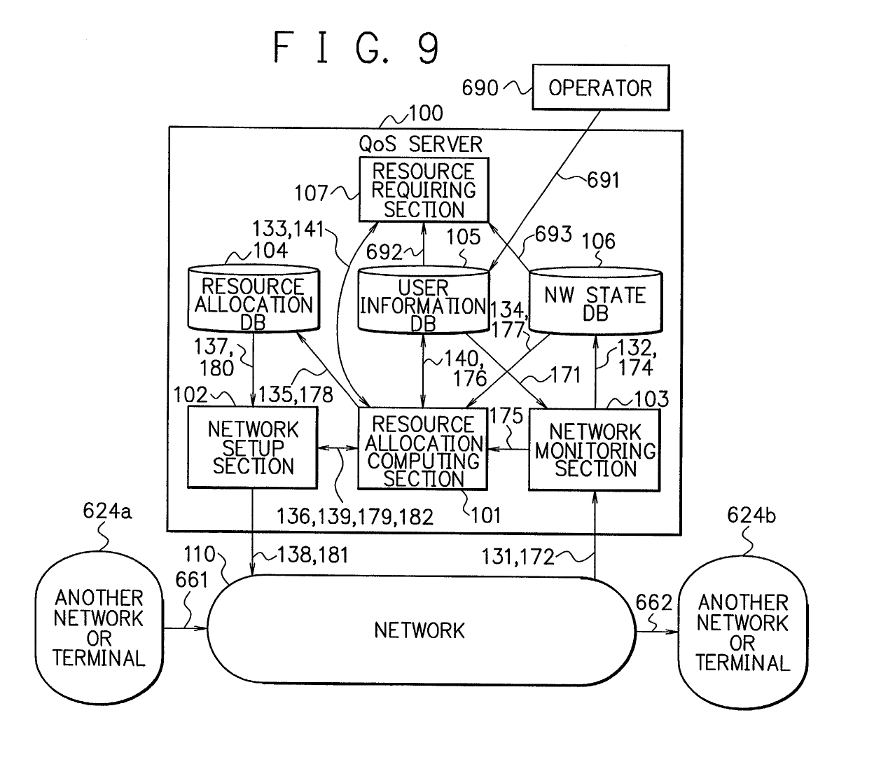

In the following, the fourth embodiment of the present invention will be explained. The present invention is applicable to an application that does not have a signaling function. FIG. 9 is a block diagram showing a network system, in which the present invention is applied to an application having no signaling function. Here, the network 110 is connected to other networks or terminals, which are denoted by reference numerals 624a and 624b, respectively. The other networks or terminals 624a and 624b belong to the category of outside networks.

Since the application does not have signaling, there is neither signaling gateway nor call agent. In an example of FIG. 9, the resource requiring section 107 is located in the QoS server 100.

An operator 690 sets traffic identification information and QoS requirements information of applications that the QoS server 100 is to support at the user information database 105 as setup information 691. The resource requiring section 107 retrieves information 692 of an application to support from the setup information 691 in the user information database 105, and at the time of initial setting for the network 110, sends resource requirements 133 to the resource allocation computing section 101 similarly to the first embodiment. After the completion of resource allocation, the network monitoring section 103 monitors the network 110 using a signal 172, and detects an increase/decrease in calls of application traffic 693 from application traffic information 174 stored in the network state database 106. Accordingly, the resource requiring section 107 sends additional resource request/resource release request 141 to a resource allocation computing section 101.

As shown in FIG. 9, in the network system in the fourth embodiment, other dispositions and operations are the same as those illustrated in FIGS. 4 and 7 except that the signaling architecture is not provided. That is, the fourth embodiment also includes the steps as follows: (1) traffic requirements and resource requirements are previously obtained to compute path and resource allocation, and the path and resource allocation is conducted before a call arrives; (2) traffic requirements and resource requirements of aggregate calls are obtained to compute path and resource allocation, and the path and resource allocation is conducted; (3) when the number of connected calls exceeds a certain threshold, traffic requirements and resource requirements for additional aggregate calls are obtained to re-compute resource allocation, and the additional resource allocation is conducted; (4) when the number of connected calls underruns a certain threshold, resource release request for aggregate calls are obtained, and the resource release is conducted to reduce reserved resource; and (5) traffic flow on the allocated resources is monitored, and when it is detected that the required quality is not satisfied, path and resource allocation is re-computed and altered.

As set forth hereinabove, in accordance with the present invention, a QoS server is provided with interfaces with applications and thus obtaining QoS requirements and resource requirements of the applications. Therefore, it is possible to conduct resource allocation that satisfies the requirements of applications. Besides, the QoS server monitors a network to feed back the network state and traffic state to resource allocation to applications. Thus, it is possible to conduct resource allocation according to the network state. Additionally, on this occasion, a failure of resources and deterioration in the quality of application traffics, to which resources are allocated, are detected, and thereby resource allocation is changed to avoid call defects. Consequently, dynamic resource allocation and network design can be realized without settings by an operator.

Moreover, resource allocation is executed with respect to an aggregate of calls before calls reach from applications, and therefore the process of resource allocation does not cause a delay in call setup. Furthermore, call setup signaling and resource allocation signaling are partitioned, and thus applications can continue call setup even when failures occur in the QoS server.

While the preferred embodiments of the present invention have been described using specific terms, such description is for illustrative purposes only, and it is to be understood that changes and variations may be made without departing from the spirit or the scope of the following claims.

What is claimed is:

1. A QoS server, which is used in a network system comprising: a network, main signal gateways for accommodating outside networks in the network and executing conversion of main signals between the network and the outside networks, a call setup server for setting up a call, and signaling gateways for executing conversion of signaling signals between the call setup server and the outside networks, including:
a network monitoring section for monitoring the network state;
a network state database for storing network state information obtained at the network monitoring section;
a resource allocation computing section for computing resource allocation for applications based on resource requirements with reference to the network state information;
a resource allocation database for storing resource allocation information; and
a network setup section for setting up resource allocation on the network based on the resource allocation information.

2. The QoS server claimed in claim 1, wherein resource allocation is conducted based on the resource requirements from a resource requiring section that makes resource requirements located in the call setup server.

3. The QoS server claimed in claim 1, wherein, resource allocation is conducted based on the resource requirements from a resource requiring section that makes resource requirements located in the main signal gateway.

4. A QoS server, which is used in a network system comprising: a network being connected to outside networks, and a policy server for deciding a policy for the network and setting up resource allocation on the network, including:
a network monitoring section for monitoring the network state;
a network state database for storing network state information obtained at the network monitoring section; and
a resource allocation computing section for computing resource allocation for applications based on resource requirements with reference to the network state information and notifying the policy server of resource allocation information.

5. The QoS server claimed in claim 4, wherein resource allocation is conducted based on the resource requirements from a resource requiring section that makes resource requirements located in the policy server.

6. A QoS server for setting up resource allocation on a network which is connected to outside networks, including:
a network monitoring section for monitoring the network state;
a network state database for storing network state information obtained at the network monitoring section;
a user information database for storing setup information;
a resource requiring section for making resource requirements with reference to the network state information in the network state database and the setup information in the user information database;
a resource allocation computing section for computing resource allocation for applications based on the resource requirements with reference to the network state information;
a resource allocation database for storing resource allocation information; and
a network setup section for setting up resource allocation on the network based on the resource allocation information.

7. The QoS server claimed in claim 1, which previously obtains traffic requirements and resource requirements to compute path and resource allocation, and conducts path and resource allocation before a call arrives on the network.

8. The QoS server claimed in claim 2, which previously obtains traffic requirements and resource requirements to compute path and resource allocation, and conducts path and resource allocation before a call arrives on the network.

9. The QoS server claimed in claim 3, which previously obtains traffic requirements and resource requirements to compute path and resource allocation, and conducts path and resource allocation before a call arrives on the network.

10. The QoS server claimed in claim 4, which previously obtains traffic requirements and resource requirements to compute path and resource allocation, and conducts path and resource allocation before a call arrives on the network.

11. The QoS server claimed in claim 5, which previously obtains traffic requirements and resource requirements to compute path and resource allocation, and conducts path and resource allocation before a call arrives on the network.

12. The QoS server claimed in claim 6, which previously obtains traffic requirements and resource requirements to compute path and resource allocation, and conducts path and resource allocation before a call arrives on the network.

13. The QoS server claimed in claim 1, which obtains traffic requirements and resource requirements of calls to compute path and resource allocation for an aggregate of calls, and conducts path and resource allocation.

14. The QoS server claimed in claim 2, which obtains traffic requirements and resource requirements of calls to compute path and resource allocation for an aggregate of calls, and conducts path and resource allocation.

15. The QoS server claimed in claim 3, which obtains traffic requirements and resource requirements of calls to compute path and resource allocation for an aggregate of calls, and conducts path and resource allocation.

16. The QoS server claimed in claim 4, which obtains traffic requirements and resource requirements of calls to compute path and resource allocation for an aggregate of calls, and conducts path and resource allocation.

17. The QoS server claimed in claim 5, which obtains traffic requirements and resource requirements of calls to compute path and resource allocation for an aggregate of calls, and conducts path and resource allocation.

18. The QoS server claimed in claim 6, which obtains traffic requirements and resource requirements of calls to compute path and resource allocation for an aggregate of calls, and conducts path and resource allocation.

19. The QoS server claimed in claim 1, which obtains traffic requirements and resource requirements of additional aggregate calls, when the number of connected calls exceeds a certain threshold, to re-compute path and resource allocation, and renews the threshold after additional path and resource allocation.

20. The QoS server claimed in claim 2, which obtains traffic requirements and resource requirements of additional aggregate calls, when the number of connected calls exceeds a certain threshold, to re-compute path and resource allocation, and renews the threshold after additional path and resource allocation.

21. The QoS server claimed in claim 3, which obtains traffic requirements and resource requirements of additional aggregate calls, when the number of connected calls exceeds a certain threshold, to re-compute path and resource allocation, and renews the threshold after additional path and resource allocation.

22. The QoS server claimed in claim 4, which obtains traffic requirements and resource requirements of additional aggregate calls, when the number of connected calls exceeds a certain threshold, to re-compute path and resource allocation, and renews the threshold after additional path and resource allocation.

23. The QoS server claimed in claim 5, which obtains traffic requirements and resource requirements of additional aggregate calls, when the number of connected calls exceeds a certain threshold, to re-compute path and resource allocation, and renews the threshold after additional path and resource allocation.

24. The QoS server claimed in claim 6, which obtains traffic requirements and resource requirements of additional aggregate calls, when the number of connected calls exceeds a certain threshold, to re-compute path and resource allocation, and renews the threshold after additional path and resource allocation.

25. The QoS server claimed in claim 1, which obtains a request for resource release for aggregate calls when the number of connected calls underruns a certain threshold, and renews the threshold after resource release.

26. The QoS server claimed in claim 2, which obtains a request for resource release for aggregate calls when the number of connected calls underruns a certain threshold, and renews the threshold after resource release.

27. The QoS server claimed in claim 3, which obtains a request for resource release for aggregate calls when the number of connected calls underruns a certain threshold, and renews the threshold after resource release.

28. The QoS server claimed in claim 4, which obtains a request for resource release for aggregate calls when the number of connected calls underruns a certain threshold, and renews the threshold after resource release.

29. The QoS server claimed in claim 5, which obtains a request for resource release for aggregate calls when the number of connected calls underruns a certain threshold, and renews the threshold after resource release.

30. The QoS server claimed in claim 6, which obtains a request for resource release for aggregate calls when the number of connected calls underruns a certain threshold, and renews the threshold after resource release.

31. The QoS server claimed in claim 1, further including a user information database for storing the resource requirements, which monitors traffic flow corresponding to the allocated resources, and when detecting that the required quality is not satisfied, re-computes path and resource allocation with reference to the user information database to alter path and resource allocation.

32. The QoS server claimed in claim 2, further including a user information database for storing the resource requirements, which monitors traffic flow corresponding to the allocated resources, and when detecting that the required quality is not satisfied, re-computes path and resource allocation with reference to the user information database to alter path and resource allocation.

33. The QoS server claimed in claim 3, further including a user information database for storing the resource requirements, which monitors traffic flow corresponding to the allocated resources, and when detecting that the required quality is not satisfied, re-computes path and resource allocation with reference to the user information database to alter path and resource allocation.

34. The QoS server claimed in claim 4, further including a user information database for storing the resource requirements, which monitors traffic flow corresponding to the allocated resources, and when detecting that the required quality is not satisfied, re-computes path and resource allocation with reference to the user information database to alter the path and resource allocation.

35. The QoS server claimed in claim 5, further including a user information database for storing the resource requirements, which monitors traffic flow corresponding to the allocated resources, and when detecting that the required quality is not satisfied, re-computes path and resource allocation with reference to the user information database to alter the path and resource allocation.

36. The QoS server claimed in claim 6, which monitors traffic flow corresponding to the allocated resources, and when detecting that the required quality is not satisfied, re-computes path and resource allocation to alter the path and resource allocation.

37. A resource allocation control method in a network system comprising: a network, main signal gateways for accommodating outside networks in the network and executing conversion of main signals between the network and the outside networks, a call setup server for setting up a call, and signaling gateways for executing conversion of signaling signals between the call setup server and the outside networks, including the steps of:
monitoring the network state;
storing network state information in a network state database;
computing resource allocation for applications based on resource requirements with reference to the network state information stored in the network state database;
storing resource allocation information in a resource allocation database; and
setting up resource allocation on the network based on the resource allocation information stored in the resource allocation database

38. The resource allocation control method claimed in claim 37, wherein resource allocation is conducted based on the resource requirements from the call setup server.

39. The resource allocation control method claimed in claim 37, wherein resource allocation is conducted based on the resource requirements from the main signal gateway.

40. A resource allocation control method in a network system comprising: a network being connected to outside networks, and a policy server for deciding a policy for the network and setting up resource allocation on the network, including the steps of:
monitoring the network state;
storing network state information in a network state database;
computing resource allocation for applications based on resource requirements with reference to the network state information stored in the network state database; and
notifying the policy server of resource allocation information.

41. The resource allocation control method claimed in claim 40, wherein the resource requirements are produced in the policy server.

42. A resource allocation control method for setting up resource allocation on a network which is connected to outside networks, including the steps of:
monitoring the network state;
storing network state information in a network state database;
making resource requirements with reference to the network state information stored in the network state database and setup information stored in a user information database;
computing resource allocation for applications based on the resource requirements with reference to the network state information stored in the network state database;
storing resource allocation information in a resource allocation database; and
setting up resource allocation on the network based on the resource allocation information stored in the resource allocation database.

43. The resource allocation control method claimed in claim 37, wherein traffic requirements and resource requirements are previously obtained to compute path and resource allocation, and path and resource allocation is conducted before a call arrives on the network.

44. The resource allocation control method claimed in claim 38, wherein traffic requirements and resource requirements are previously obtained to compute path and resource allocation, and path and resource allocation is conducted before a call arrives on the network.

45. The resource allocation control method claimed in claim 39, wherein traffic requirements and resource requirements are previously obtained to compute path and resource allocation, and path and resource allocation is conducted before a call arrives on the network.

46. The resource allocation control method claimed in claim 40, wherein traffic requirements and resource requirements are previously obtained to compute path and resource allocation, and path and resource allocation is conducted before a call arrives on the network.

47. The resource allocation control method claimed in claim 41, wherein traffic requirements and resource requirements are previously obtained to compute path and resource allocation, and path and resource allocation is conducted before a call arrives on the network.

48. The resource allocation control method claimed in claim 42, wherein traffic requirements and resource requirements are previously obtained to compute path and resource allocation, and path and resource allocation is conducted before a call arrives on the network.

49. The resource allocation control method claimed in claim 37, wherein traffic requirements and resource requirements of calls are obtained to compute path and resource allocation for an aggregate of calls, and path and resource allocation is conducted.

50. The resource allocation control method claimed in claim 38, wherein traffic requirements and resource requirements of calls are obtained to compute path and resource allocation for an aggregate of calls, and path and resource allocation is conducted.

51. The resource allocation control method claimed in claim 39, wherein traffic requirements and resource requirements of calls are obtained to compute path and resource allocation for an aggregate of calls, and path and resource allocation is conducted.

52. The resource allocation control method claimed in claim 40, wherein traffic requirements and resource requirements of calls are obtained to compute path and resource allocation for an aggregate of calls, and path and resource allocation is conducted.

53. The resource allocation control method claimed in claim 41, wherein traffic requirements and resource requirements of calls are obtained to compute path and resource allocation for an aggregate of calls, and path and resource allocation is conducted.

54. The resource allocation control method claimed in claim 42, wherein traffic requirements and resource requirements of calls are obtained to compute path and resource allocation for an aggregate of calls, and path and resource allocation is conducted.

55. The resource allocation control method claimed in claim 37, wherein when the number of connected calls exceeds a certain threshold, traffic requirements and resource requirements of additional aggregate calls are obtained to re-compute path and resource allocation, and the threshold is renewed after additional path and resource allocation.

56. The resource allocation control method claimed in claim 38, wherein when the number of connected calls exceeds a certain threshold, traffic requirements and resource requirements of additional aggregate calls are obtained to re-compute path and resource allocation, and the threshold is renewed after additional path and resource allocation.

57. The resource allocation control method claimed in claim 39, wherein when the number of connected calls exceeds a certain threshold, traffic requirements and resource requirements of additional aggregate calls are obtained to re-compute path and resource allocation, and the threshold is renewed after additional path and resource allocation.

58. The resource allocation control method claimed in claim 40, wherein when the number of connected calls exceeds a certain threshold, traffic requirements and resource requirements of additional aggregate calls are obtained to re-compute path and resource allocation, and the threshold is renewed after additional path and resource allocation.

59. The resource allocation control method claimed in claim 41, wherein when the number of connected calls exceeds a certain threshold, traffic requirements and resource requirements of additional aggregate calls are obtained to re-compute path and resource allocation, and the threshold is renewed after additional path and resource allocation.

60. The resource allocation control method claimed in claim 42, wherein when the number of connected calls exceeds a certain threshold, traffic requirements and resource requirements of additional aggregate calls are obtained to re-compute path and resource allocation, and the threshold is renewed after additional path and resource allocation.

61. The resource allocation control method claimed in claim 37, wherein when the number of connected calls underruns a certain threshold, a request for resource release for reduced calls is obtained and the threshold is renewed after resource release.

62. The resource allocation control method claimed in claim 38, wherein when the number of connected calls underruns a certain threshold, a request for resource release for reduced calls is obtained and the threshold is renewed after resource release.

63. The resource allocation control method claimed in claim 39, wherein when the number of connected calls underruns a certain threshold, a request for resource release for reduced calls is obtained and the threshold is renewed after resource release.

64. The resource allocation control method claimed in claim 40, wherein when the number of connected calls underruns a certain threshold, a request for resource release for reduced calls is obtained and the threshold is renewed after resource release.

65. The resource allocation control method claimed in claim 41, wherein when the number of connected calls underruns a certain threshold, a request for resource release for reduced calls is obtained and the threshold is renewed after resource release.

66. The resource allocation control method claimed in claim 42, wherein when the number of connected calls underruns a certain threshold, a request for resource release for reduced calls is obtained and the threshold is renewed after resource release.

67. The resource allocation control method claimed in claim 37, wherein:
a user in formation database stores the resource requirements; and
traffic flow corresponding to the allocated resources is monitored, and when it is detected that the required quality is not satisfied, path and resource allocation is re-computed with reference to the user information database and altered.

68. The resource allocation control method claimed in claim 38, wherein:
a user information database stores the resource requirements; and
traffic flow corresponding to the allocated resources is monitored, and when it is detected that the required quality is not satisfied, path and resource allocation is re-computed with reference to the user information database and altered.

69. The resource allocation control method claimed in claim 39, wherein:
a user information database stores the resource requirements; and
traffic flow corresponding to the allocated resources is monitored, and when it is detected that the required quality is not satisfied, path and resource allocation is re-computed with reference to the user information database and altered.

70. The resource allocation control method claimed in claim 40, wherein:
a user information database stores the resource requirements; and
traffic flow corresponding to the allocated resources is monitored, and when it is detected that the required quality is not satisfied, path and resource allocation is re-computed with reference to the user information database and altered.

71. The resource allocation control method claimed in claim 41, wherein:
a user information database stores the resource requirements; and
traffic flow corresponding to the allocated resources is monitored, and when it is detected that the required quality is not satisfied, path and resource allocation is re-computed with reference to the user information database and altered.

72. The resource allocation control method claimed in claim 42, wherein traffic flow corresponding to the allocated resources is monitored, and when it is detected that the required quality is not satisfied, path and resource allocation is re-computed and altered.
